(19) United States
(12) Patent Application Publication
(10) Pub. No.: US 2015/0082981 A1
(43) Pub. Date: Mar. 26, 2015

(54) CAPTURE OF TRIFLUOROMETHANE USING IONIC LIQUIDS

(71) Applicant: E I DU PONT DE NEMOURS AND COMPANY, Wilmington, DE (US)

(72) Inventor: Mark Brandon Shiflett, Wilmington, DE (US)

(73) Assignee: E I DU PONT DE NEMOURS AND COMPANY, Wilmington, DE (US)

(21) Appl. No.: 14/032,209

(22) Filed: Sep. 20, 2013

(51) Int. Cl. B01D 53/14

(52) U.S. Cl. CPC B01D 53/1493; B01D 53/1487; B01D 2252/20473; B01D 2252/30
USPC 95/237

(57) ABSTRACT

A method for capturing trifluoromethane from a gaseous mixture in a vent stream from a chlorodifluoromethane manufacturing process using ionic liquids is described. The method is useful for reducing emissions of trifluoromethane, which has a high global warming potential.

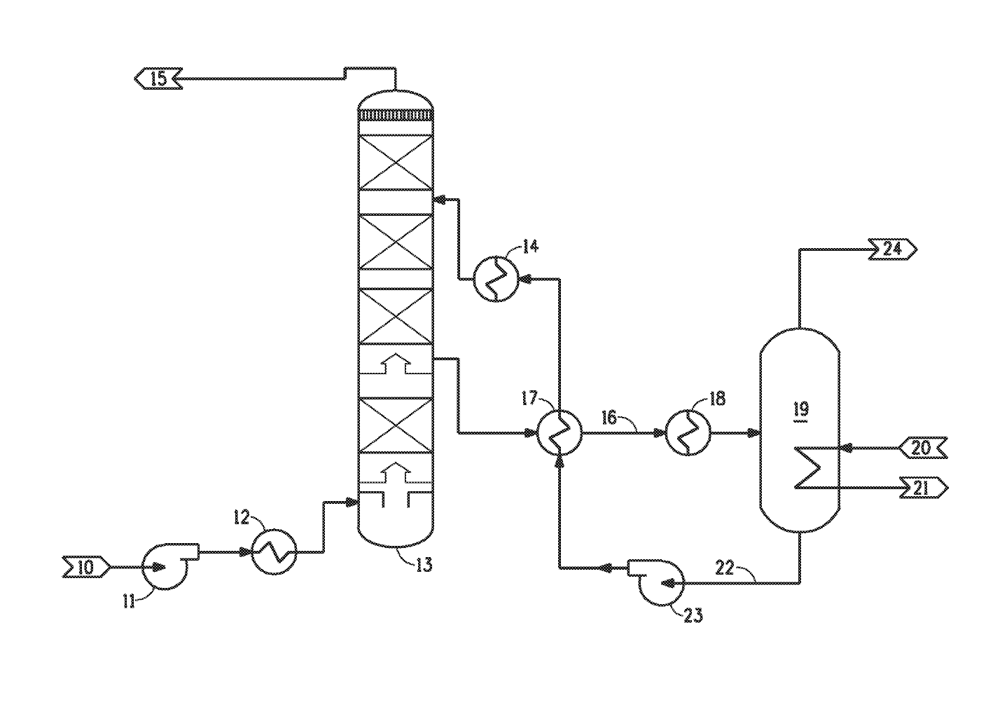

This application claims priority under 35 U.S.C. §119(e) from, and claims the benefit of, U.S. Provisional Application No. 61/708,652 filed 2 Oct. 2012, which is by this reference incorporated in its entirety as a part hereof for all purposes.

### TECHNICAL FIELD

The invention relates to the field of greenhouse gas emission reduction. More specifically, the invention provides a method for capturing trifluoromethane from a gaseous mixture using ionic liquids.

### BACKGROUND

Chlorodifluoromethane (R-22) is widely used as a propellant and refrigerant, and is also a versatile intermediate in the synthesis of organofluorine compounds. Chlorodifluoromethane is typically prepared by reacting chloroform with HF. A by-product of this reaction is trifluoromethane (R-23), which has a very high global warming potential (i.e., GWP=11,700 relative to CO₂ GWP=1). Therefore, methods to capture the trifluoromethane produced in the chlorodifluoromethane manufacturing process are needed to prevent its release into the atmosphere.

Ionic liquids have been used as adsorbents in separation of various gases, including hydrofluorocarbons. For example, ionic liquids have been used in a process to separate close-boiling and azeotropic components of mixtures wherein the mixtures contain at least one hydrofluorocarbon compound (Shiflett et al. U.S. Patent Application Publication No. 2007/0131535 A1). Shiflett et al. (U.S. Patent Application Publication No. 2008/0293978 A1) also describe a process for separating 1,1,2,2-tetrafluoroethane or 1,1,1,2-tetrafluoroethane from a mixture containing both compounds using ionic liquids to enhance the efficiency of the separation. Additionally, Shiflett et al. describe utilizing ionic liquids as working fluid in an absorption refrigeration cycle (U.S. Patent Application Publication No. 2006/0197053 A1 and U.S. Patent Application Publication No. 2007/0144186 A1). However, ionic liquids have not been used to capture trifluoromethane produced in the chlorodifluoromethane manufacturing process.

### SUMMARY

In one embodiment, there is provided herein, a method for capturing trifluoromethane from a gaseous mixture comprising the step of: contacting the gaseous mixture with at least one ionic liquid at a pressure of about 0.1 MPa to about 4.8 MPa and a temperature of about 273 K to about 323 K for a period of time sufficient for the ionic liquid to absorb at least a portion of the trfluoromethane; wherein:
(a) the gaseous mixture is a vent stream from a chlorodifluoromethane manufacturing process, said gaseous mixture consisting essentially of trifluoromethane and nitrogen, oxygen, argon, and/or carbon dioxide; and
(b) the ionic liquid comprises a cation and a fluorinated anion, said cation is selected from the group consisting of cations represented by the structures of the following formulae:

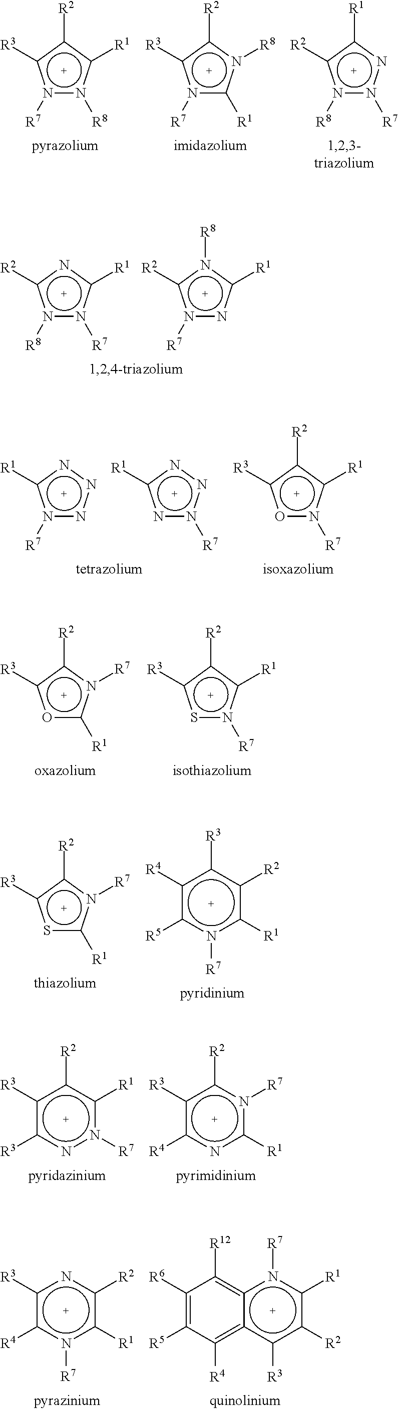

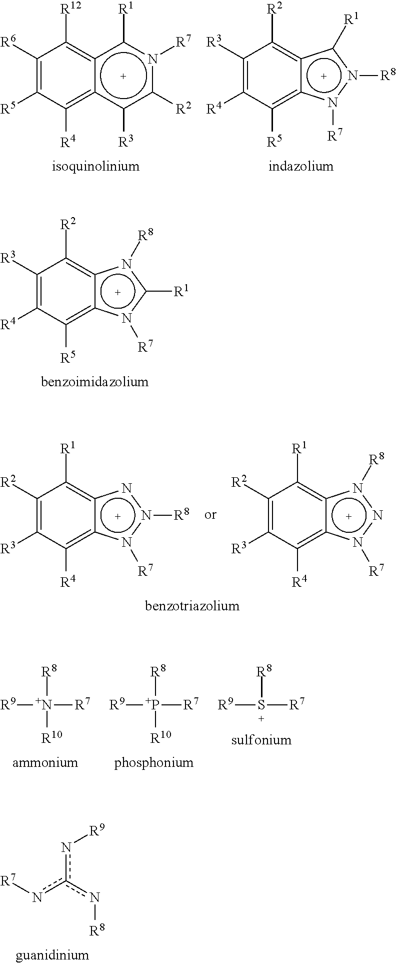

wherein:
(I) R¹, R², R³, R⁴, R⁵, R⁶, and R¹² are independently selected from the group consisting of:
   (i) H,
   (ii) halogen,
   (iii) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
   (iv) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (v) C₆ to C₂₀ unsubstituted aryl, or C₁ to C₂₅ unsubstituted heteroaryl having one to three heteroatoms independently selected from the group consisting of O, N, Si and S;
   (vi) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
      (B) OH,
      (C) NH₂, and
      (D) SH; and
   (vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;
(II) R⁷, R⁸, R⁹, and R¹⁰ are independently selected from the group consisting of:
   (ix) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
   (x) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (xi) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
      (F) OH,
      (G) NH₂, and
      (H) SH; and
   (xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(III) optionally at least two of R¹, R², R³, R⁴, R⁵, R⁶, R⁷, R⁸, R⁹, and R¹⁰ can together form a cyclic or bicyclic alkanyl or alkenyl group.

### BRIEF DESCRIPTION OF THE DRAWING

The FIGURE is a flow diagram of an exemplary system for use in the capture of trifluoromethane using the method described herein.

### DETAILED DESCRIPTION

As used above and throughout the description of the invention, the following terms, unless otherwise indicated, shall be defined as follows:

The term “ionic liquid” refers to an organic salt that is fluid at or below about 100° C.

The term “gaseous mixture”, as used herein, refers to a mixture of gases in a vent stream from a chlorodifluoromethane manufacturing process. The gaseous mixture consists essentially of trifluoromethane and nitrogen, oxygen, argon, and/or carbon dioxide. The gaseous mixture may also contain small amounts of chlorodifluoromethane and/or HCl, typically less than 5 wt %.

The terms “capture” and “capturing”, as used herein, refer to the removal of at least a portion of the trifluoromethane from a gaseous mixture by absorption into an ionic liquid.

The term “fluorinated anion” as used herein, refers to a negatively charged ion that contains at least one fluorine atom.

Disclosed herein is a method for capturing trifluoromethane from a gaseous mixture in a vent stream from a chlorodifluoromethane manufacturing process using ionic liquids. The method is useful for reducing emissions of trifluoromethane, which has a high global warming potential (i.e., GWP=11,700 relative to CO₂ GWP=1).

### Ionic Liquids

Ionic liquids suitable for use as disclosed herein can, in principle, be any ionic liquid that absorbs trifluoromethane; however, ionic liquids that have minimal absorption of trifluoromethane will be less effective. Ideally, ionic liquids having high absorption of trifluoromethane are desired for efficient use as described herein. In particular, ionic liquids having a fluorinated anion are most useful for absorbing trifluoromethane. Additionally, mixtures of two or more ionic liquids may be used.

Many ionic liquids are formed by reacting a nitrogen-containing heterocyclic ring, preferably a heteroaromatic ring, with an alkylating agent (for example, an alkyl halide) to form a cation. Examples of suitable heteroaromatic rings include substituted pyridines and imidazoles. These rings can be alkylated with virtually any straight, branched or cyclic C₁₋₂₀ alkyl group, but preferably, the alkyl groups are C₁₋₁₆ groups. Various other cations such as ammonium, phosphonium, sulfonium, and guanidinium may also be used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany), BASF (Mount Olive, N.J.), Fluka Chemical Corp. (Milwaukee, Wis.), and Sigma-Aldrich (St. Louis, Mo.). For example, the synthesis of many ionic liquids is described by Shiflett et al. (U.S. Patent Application Publication No. 2006/0197053.

Representative examples of ionic liquids suitable for use herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references cited therein). In one embodiment, a library, i.e., a combinatorial library, of ionic liquids may be prepared, for example, by preparing various alkyl derivatives of a quaternary ammonium cation, and varying the associated anions.

Ionic liquids suitable for use herein comprise a cation and a fluorinated anion. The cation is selected from the group consisting of cations represented by the structures of the following formulae:

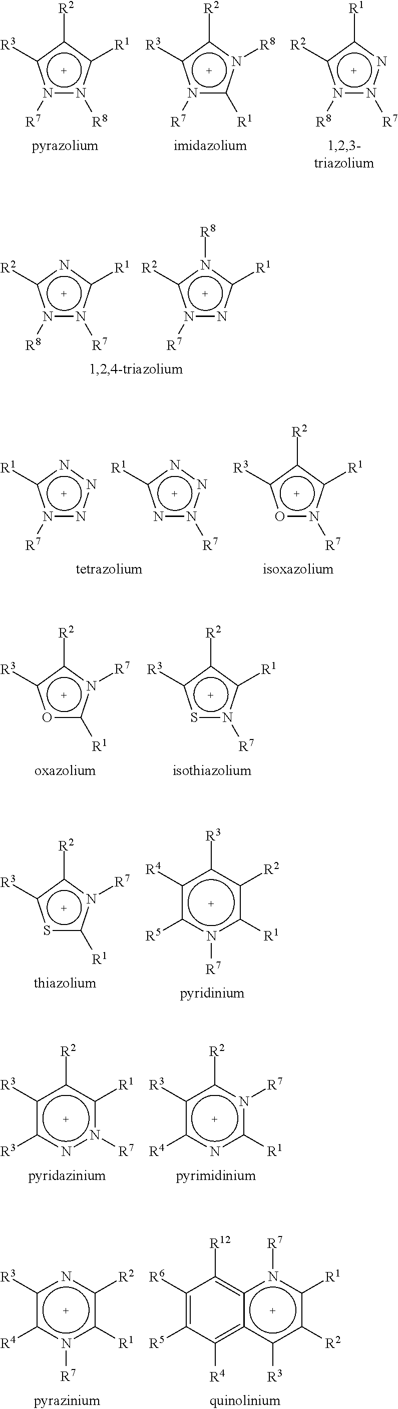

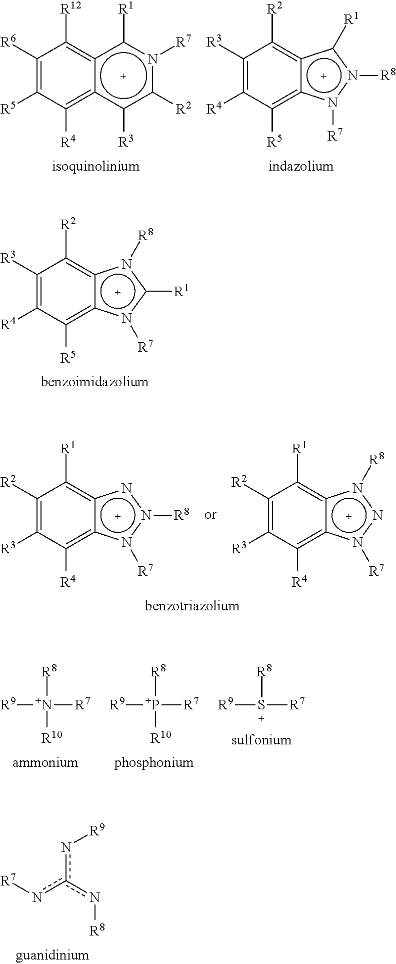

wherein:
a) R¹, R², R³, R⁴, R⁵, R⁶, and R¹² are independently selected from the group consisting of:
   (i) H,
   (ii) halogen,
   (iii) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
   (iv) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (v) C₆ to C₂₀ unsubstituted aryl, or C₁ to C₂₅ unsubstituted heteroaryl having one to three heteroatoms independently selected from the group consisting of O, N, Si and S;
   (vi) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
      (B) OH,
      (C) NH₂, and
      (D) SH; and
   (vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;
b) R⁷, R⁸, R⁹, and R¹⁰ are independently selected from the group consisting of:
   (ix) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
   (x) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
   (xi) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
      (E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
      (F) OH,
      (G) NH₂, and
      (H) SH; and
   (xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
c) optionally at least two of R¹, R², R³, R⁴, R⁵, R⁶, R⁷, R⁸, R⁹, and R¹⁰ can together form a cyclic or bicyclic alkanyl or alkenyl group.

Ionic liquids suitable for use as disclosed herein comprise a fluorinated anion. In one embodiment, the fluorinated anion is selected from one or more members of the group consisting of tetrafluoroborate, [BF₄]⁻, [PF₆]⁻, [SbF₆], [CF₃SO₃]⁻, [HCF₂CF₂SO₃], [CF₃HFCCF₂SO₃]⁻, [HCCIFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃]⁻, [(CF₂HCF₂SO₂)₂N]⁻, [(CF₃CFHCF₂SO₂)₂N]⁻, and F⁻.

In another embodiment, the ionic liquid comprises a fluorinated anion selected from one or more members of the group consisting of 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

In one embodiment, the ionic liquid comprises a cation selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

In one embodiment the ionic liquid is 1-octyl-3-methylimidazolium 1,1,2,2-tetrafluoroethanesulfonate, also referred to herein as [omim][TFES].

### Method for Capturing Trifluoromethane

The method disclosed herein is useful for capturing trifluoromethane from a gaseous mixture in a vent stream from a chlorodifluoromethane manufacturing process. Chlorodifluoromethane is prepared by reacting chloroform with HF according to the following reaction:

HCCl₃+2HF→HCF₂Cl+2HCl

Trifluoromethane is a by-product of this reaction, typically present at a level of less than 5 wt %. The chlorodifluoromethane is separated from the trifluoromethane by a distillation process, resulting in a mixture containing primarily trifluoromethane and HCl. The HCl is removed from the mixture by a scrubbing process which utilizes water. Residual trifluoromethane dissolved in the scrubbing solution is removed using inert gas such as air, argon, or nitrogen, resulting in a gaseous mixture consisting essentially of trifluoromethane and nitrogen, oxygen, argon, and/or carbon dioxide. The gaseous mixture may also contain small amounts of chlorodifluoromethane and/or HCl, typically less than 5 wt %. This gaseous mixture is typically vented into the atmosphere as a vent stream. However, it is desirable to capture the trifluoromethane in the vent stream to prevent its release into the atmosphere because of the very high global warming potential of trifluoromethane (i.e., GWP=11,700 relative to CO₂ GWP=1).

In the method disclosed herein, the gaseous mixture in the vent stream from a chlorodifluoromethane manufacturing process is contacted with at least one ionic liquid, described above, at a pressure of about 0.1 MPa to about 4.8 MPa, and a temperature of about 273 K to about 323 K for a period of time sufficient for the ionic liquid to absorb at least a portion of the trfluoromethane present in the gaseous mixture. Ideally, substantially all of the trfluoromethane is absorbed by the ionic liquid. Suitable conditions for the capture of the trfluoromethane from the gaseous mixture may be determined by one skilled in the art using routine experimentation. In some embodiments, the gaseous mixture is contacted with the ionic liquid at a pressure of about 0.5 MPa to about 4.5 MPa, more particularly about 1.0 MPa to about 4.5 MPa, and more particularly about 2.0 MPa to about 4.5 MPa.

In some embodiments, the gaseous mixture is contacted with the ionic liquid at a temperature of about 283 K to about 323 K, more particularly about 298 K to about 323 K.

The trifluoromethane captured by the ionic liquid may be recovered and the ionic liquid regenerated in various ways. For example, the ionic liquid containing the absorbed trfluoromethane may be heated in a stripping column to release the trfluoromethane and regenerate the ionic liquid. Alternatively, the ionic liquid containing the absorbed trfluoromethane may be regenerated using a flash technique in which the pressure is reduced and the ionic liquid is heated to release the absorbed trfluoromethane. The released trfluoromethane may be incinerated or liquefied by pressurizing for storage.

An exemplary system for carrying out one embodiment of the method disclosed herein for capturing trfluoromethane from a gaseous mixture in a vent stream from a chlorodifluoromethane manufacturing process is shown in the FIGURE. Referring to the FIGURE, the gaseous mixture from the vent stream 10 comprising trfluoromethane and other gases such as nitrogen, oxygen, argon, and/or carbon dioxide may be compressed by passage through compressor 11 and then optionally cooled by a prechiller 12. The compressed and optionally cooled gas mixture enters the bottom of absorption column 13, where it is contacted with the ionic liquid, whereby at least a portion of the trfluoromethane is absorbed by the ionic liquid. The ionic liquid is cooled by precooler 14 before entry into the absorption column 13. The treated gas mixture 15, having at least a portion of the trfluoromethane removed, is vented from the top of the absorption column 13. The ionic liquid containing the absorbed trfluoromethane 16 exits the absorption column 13 and enters a process heat exchanger 17. Next, the ionic liquid passes through a flash preheater 18 and enters flash tank 19. The flash tank is essentially a simple single stage stripper where the ionic liquid containing absorbed trfluoromethane is regenerated by heating with steam 20. The condensate from the steam 21 exits the flash tank 19 and may be heated to regenerate the steam. The regenerated ionic liquid 22 exits the bottom of the flash tank 19 and is pumped by recycle pump 23 back through the process heat exchanger 17 and cooled before entering the absorption column 13. Due to the very low vapor pressure of the ionic liquid, the flash tank vapor is assumed to contain only trfluoromethane 24 and a condenser is not required. The trfluoromethane 24 exiting the flash tank 19 may be incinerated or liquefied by pressurizing for storage.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “mL” means milliliter(s), “μL” means microliter(s), “g” means gram(s), “mg” means milligram(s), “μg” means microgram(s), “Pa” means pascal(s), “kPa” means kilopascal(s), and “MPa” means megapascal(s).

Materials Trifluoromethane (R-23, CHF₃, purity>99.995%, molecular weight 70.014 g mol⁻¹, CAS no. 75-46-7) was purchased from GTS-Welco (Allentown, Pa.).

1-Octyl-3-methylimidazolium 1,1,2,2-tetrafluoroethanesulfonate ([omim][TFES], C₁₄H₂₄F₄N₂O₂S, assay ≧99%, molecular weight 376.41 g mol⁻¹) was synthesized as described in U.S. Patent Application Publication No. 2006/0197053 A1.

The mass fraction of water in the [omim][TFES] was measured by Karl-Fischer titration (Aqua-Star C3000, solutions AquaStar Coulomat C and A). The [omim][TFES] was dried and degassed by first filling a borosilicate glass tube with about 10 g of the ionic liquid and pulling a coarse vacuum with a diaphragm pump (Pfeiffer, model MVP055-3, Nashua, N.H.) for about 3 h. Next, the [omim][TFES] was completely evacuated using a turbopump (Pfeiffer, model TSH-071) to a pressure of about 4×10⁻⁷ kPa while simultaneously heating and stirring the ionic liquid at a temperature of about 333 K for 6 days. The final mass fraction of water was measured by Karl-Fischer titration and the dried sample contained less than 0.0143±0.001 mass % H₂O (143±10 ppm H₂O). The [omim][TFES] sample was further purified under vacuum at a temperature of 348 K using the microbalance to remove trace amounts of water as described in Example 1.

### Example 1

### Solubility of Trifluoromethane in the Ionic Liquid [Omim][TFES]

This Example illustrates the solubility of trifluoromethane in the ionic liquid [omim][TFES] at temperatures of 298 K and 323 K. The adsorption was measured using a gravimetric microbalance.

The gas solubility measurements were made using a gravimetric microbalance (IGA-003 Multicomponent Analyzer, Hiden Isochema Ltd., Warrington WA5 7TN UK). The IGA design integrates precise computer-control and measurement of weight change, pressure and temperature to enable fully automatic and reproducible determination of gas absorption isotherms and isobars. The microbalance consists of an electrobalance with sample and counterweight components inside a stainless steel pressure-vessel. The balance has a weigh range of 0-100 mg with a resolution of 0.1 μg. An enhanced pressure stainless steel (SS316LN) reactor capable of operation to 2.0 MPa and 773.15 K was installed. The advantages of using a microbalance include the minimal sample size (<100 mg) required, the ability to automate the measurement process to take several PTx data, and the flexibility to measure both absorption and desorption isotherms. When done properly, the gravimetric analysis provides a direct an accurate method for assessing both gas solubility and diffusivity. Two critical factors that must be considered include properly correcting for the buoyancy effects of the system and allowing sufficient time to reach equilibrium (i.e., no mixing is possible).

Approximately 50 mg of the ionic liquid was loaded into a quartz glass container inside the microbalance. The reactor was sealed and evacuated. The ionic liquid was further dried by heating for 24 h at 323 K until no noticeable mass change was detected.

The IGA-003 can operate in both dynamic and static modes. All absorption measurements were performed in static mode. Static mode operation introduces gas into the top of the balance away from the sample, and both the admittance and exhaust valves control the set-point pressure. The sample temperature was measured with a resistance temperature device (RTD) with an accuracy of ±0.1 K. The RTD was calibrated using a standard platinum resistance thermometer (SPRT model 5699, Hart Scientific, American Fork, Utah, range 73 to 933 K) and readout (Blackstack model 1560 with SPRT module 2560). The Blackstack instrument and SPRT are a certified secondary temperature standard with a NIST traceable accuracy to ±0.005 K. Two isotherms of about 298 and 323 K were measured beginning with 298 K. Two pressure sensors were used for the measurements. Pressures from 10⁻⁴ to 10⁻² MPa were measured using a capacitance manometer (MKS, model Baratron 626A) with an accuracy of ±0.015 kPa. Pressures from 10⁻² to 2.0 MPa were measured using a piezo-resistive strain gauge (Druck, model PDCR4010) with an accuracy of ±0.8 kPa. The Druck low-pressure transducer was calibrated against a Paroscientific Model 765-15A (Redmond, Wash.) pressure transducer (range 0 to 0.102 MPa, part no. 1100-001, serial no. 104647). The Druck high-pressure transducer was calibrated against a Paroscientific Model 765-1K (Redmond, Wash.) pressure transducer (range 0 to 6.805 MPa, part no. 1100-017, serial no. 101314). These instruments are also a NIST certified secondary pressure standard with a traceable accuracy of 0.008% of full scale. The upper pressure limit of the microbalance reactor was 2.0 MPa, and several isobars up to 2.0 MPa (0.01, 0.02, 0.03, 0.04, 0.05, 0.06, 0.07, 0.08, 0.09, 0.1, 0.25, 0.50, 0.75, 1.0, 1.25, 1.5, 1.75 and 2.0 MPa) were measured. To ensure sufficient time to reach equilibrium, a minimum time of 10 h and a maximum time of 20 h were set for isotherms measured at 298 and 323 K. The total uncertainties in the solubility data due to both random and systematic errors have been estimated to be less than 0.006 mole fraction at given T and P. The equivalent uncertainty in molality for omim][TFES], was 0.0160 mol·kg⁻¹ at given T and P. The corrected solubility (PTx) data for trifluoromethane in [omim][TFES] is shown in Table 1. In the table x₁ is the mole fraction of trifluoromethane. Desorption isotherms were also measured at 298 and 323 K and the (PTx) data are included in Table 1. The trifluoromethane mass uptake versus time for absorption and desorption experiments between 0 and 2.0 MPa at 298 and 323 K indicate the sorption is reversible for [omim][TFES].

TABLE 1
Solubility Data for Trifluoromethane in [Omim][TFES]

| | | | | |
|---|---|---|---|---|
| | | | | Molality/mol |
| T/K | P/MPa | wt. % | 100 x₁ | kg⁻¹ |

Adsorption

| | | | | |
|---|---|---|---|---|
| 298.1 | 0.0521 | 0.3 | 1.4 | 0.04 |
| 298.1 | 0.1018 | 0.6 | 3.0 | 0.08 |
| 298.1 | 0.2502 | 1.5 | 7.5 | 0.22 |
| 298.1 | 0.5013 | 3.1 | 14.5 | 0.45 |
| 298.1 | 0.7499 | 4.7 | 20.9 | 0.70 |
| 298.1 | 1.0010 | 6.4 | 26.8 | 0.97 |
| 298.1 | 1.2511 | 8.1 | 32.3 | 1.27 |
| 298.1 | 1.4997 | 9.9 | 37.2 | 1.58 |
| 298.1 | 1.7507 | 11.8 | 41.9 | 1.92 |
| 298.1 | 1.9995 | 13.8 | 46.2 | 2.28 |

Desorption

| | | | | |
|---|---|---|---|---|
| 298.1 | 1.7502 | 11.8 | 41.9 | 1.91 |
| 298.1 | 1.5007 | 9.9 | 37.2 | 1.58 |
| 298.1 | 1.0007 | 6.4 | 26.8 | 0.97 |
| 298.1 | 0.7506 | 4.7 | 20.9 | 0.70 |
| 298.1 | 0.4999 | 3.1 | 14.5 | 0.45 |
| 298.1 | 0.2500 | 1.5 | 7.5 | 0.22 |
| 298.1 | 0.1001 | 0.6 | 3.0 | 0.08 |
| 298.1 | 0.0501 | 0.3 | 1.4 | 0.04 |

Adsorption

| | | | | |
|---|---|---|---|---|
| 323.2 | 0.0524 | 0.2 | 0.8 | 0.02 |
| 323.2 | 0.1004 | 0.3 | 1.8 | 0.05 |
| 323.1 | 0.2527 | 1.0 | 4.9 | 0.14 |
| 323.2 | 0.5008 | 2.0 | 9.7 | 0.29 |
| 323.1 | 0.7501 | 3.0 | 14.2 | 0.44 |
| 323.1 | 1.0011 | 4.0 | 18.4 | 0.60 |
| 323.1 | 1.2504 | 5.1 | 22.4 | 0.77 |
| 323.2 | 1.4996 | 6.1 | 25.9 | 0.93 |
| 323.1 | 1.7504 | 7.2 | 29.4 | 1.11 |
| 323.1 | 2.0007 | 8.3 | 32.8 | 1.30 |
| 323.1 | 2.0007 | 8.3 | 32.8 | 1.30 |

Desorption

| | | | | |
|---|---|---|---|---|
| 323.2 | 1.7506 | 7.2 | 29.4 | 1.11 |
| 323.1 | 1.5009 | 6.2 | 26.2 | 0.94 |
| 323.2 | 1.2506 | 5.1 | 22.4 | 0.77 |
| 323.1 | 1.0014 | 4.0 | 18.3 | 0.60 |
| 323.1 | 0.7509 | 3.0 | 14.2 | 0.44 |
| 323.1 | 0.5002 | 2.0 | 9.7 | 0.28 |
| 323.1 | 0.2507 | 0.9 | 4.8 | 0.13 |
| 323.1 | 0.1001 | 0.3 | 1.7 | 0.05 |
| 323.1 | 0.0511 | 0.1 | 0.7 | 0.02 |

What is claimed is:

1. A method for capturing trifluoromethane from a gaseous mixture comprising the step of: contacting the gaseous mixture with at least one ionic liquid at a pressure of about 0.1 MPa to about 4.8 MPa and a temperature of about 273 K to about 323 K for a period of time sufficient for the ionic liquid to absorb at least a portion of the trfluoromethane;
wherein:
(a) the gaseous mixture is a vent stream from a chlorodifluoromethane manufacturing process, said gaseous mixture consisting essentially of trifluoromethane and nitrogen, oxygen, argon, and/or carbon dioxide; and
(b) the ionic liquid comprises a cation and a fluorinated anion, said cation is selected from the group consisting of cations represented by the structures of the following formulae: 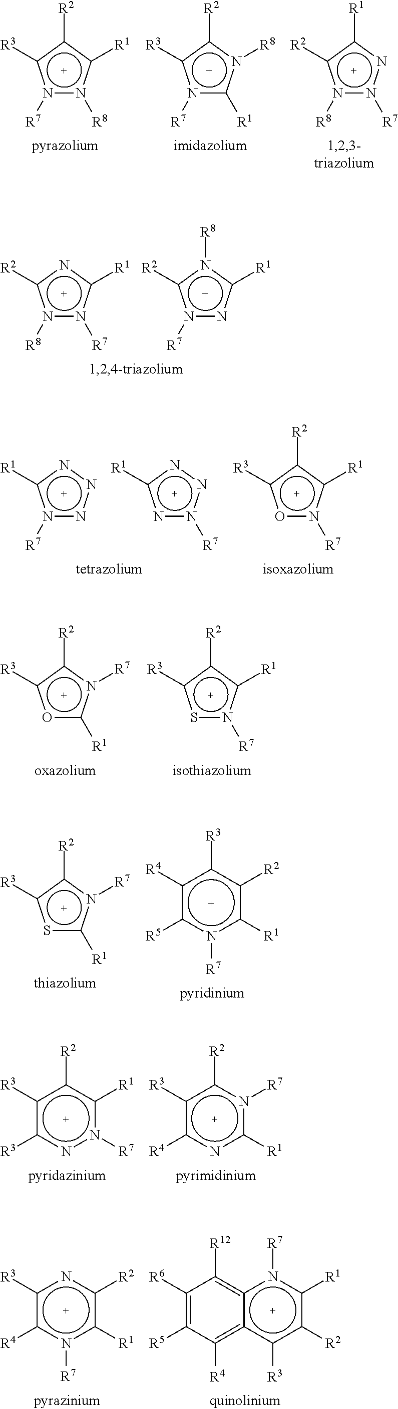 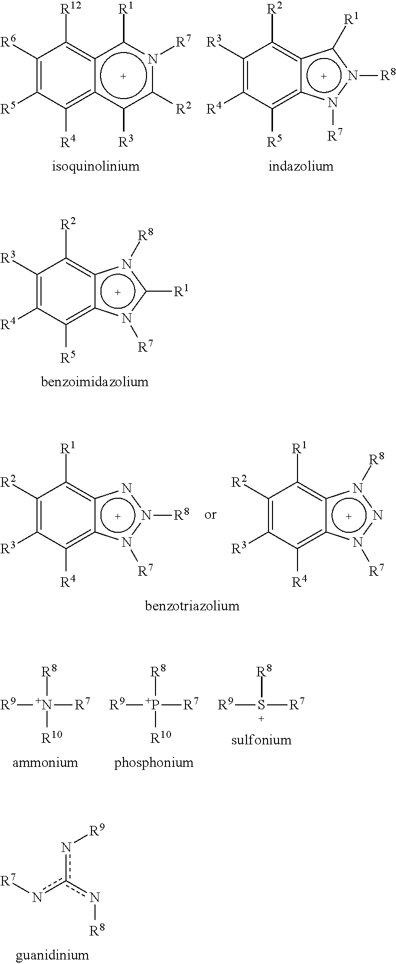
wherein:
(I) R¹, R², R³, R⁴, R⁵, R⁶, and R¹² are independently selected from the group consisting of:
(i) H,
(ii) halogen,
(iii) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₁ to C₂₅ unsubstituted heteroaryl having one to three heteroatoms independently selected from the group consisting of O, N, Si and S;
(vi) C₆ to C₂₅ substituted aryl, or C₁ to C₂₅ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
(B) OH,
(C) NH₂, and
(D) SH; and
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4;
(II) R⁷, R⁸, R⁹, and R¹° are independently selected from the group consisting of:
(ix) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₁ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₁ to C₂₅ unsubstituted heteroaryl having one to three heteroatoms independently selected from the group consisting of O, N, Si and S; and C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
(E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
(F) OH,
(G) NH₂, and
(H) SH; and
(xii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(III) optionally at least two of R¹, R², R³, R⁴, R⁵, R⁶, R⁷, R⁸, R⁹, and R¹⁰ can together form a cyclic or bicyclic alkanyl or alkenyl group.

2. The method of claim 1, wherein the fluorinated anion is selected from one or more members of the group consisting of tetrafluoroborate, [BF₄]⁻, [PF₆]⁻, [SbF₆], [CF₃SO₃]⁻, [HCF₂CF₂SO₃]⁻, [CF₃HFCCF₂SO₃]⁻, [HCCIFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃]⁻, [(CF₂HCF₂SO₂)₂N]⁻, [(CF₃CFHCF₂SO₂)₂N]⁻, and F⁻.

3. The method of claim 1, wherein the fluorinated anion is selected from one or more members of the group consisting of 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

4. The method of claim 3, wherein the fluorinated anion is 1,1,2,2-tetrafluoroethanesulfonate.

5. The method of claim 1, wherein the cation is selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

6. The method of claim 1, wherein the ionic liquid is 1-octyl-3-methylimidazolium 1,1,2,2-tetrafluoroethanesulfonate.

7. The method of claim 1, wherein the temperature is about 298 K to about 323 K.

8. The method of claim 1, wherein the pressure is about 1.0 MPa to about 4.5 MPa.
